(19) United States
(12) Patent Application Publication
(10) Pub. No.: US 2010/0202546 A1
(43) Pub. Date: Aug. 12, 2010

(54) CARRIER FREQUENCY OFFSET ESTIMATION FOR MULTICARRIER COMMUNICATION SYSTEMS

(75) Inventors: Ming Ruan, Shanghai (CN); Zhenning Shi, Shanghai (CN); Mark Reed, North Lyneham (AU)

Correspondence Address: SNELL & WILMER LLP (OC), 600 ANTON BOULEVARD, SUITE 1400, COSTA MESA, CA, 92626, US

(73) Assignee: NATIONAL ICT AUSTRALIA LIMITED, Eveleigh (AU)

(21) Appl. No.: 12/664,368

(22) PCT Filed: Jun. 18, 2008
(86) PCT No.: PCT/AU2008/000876

§ 371 Date: Apr. 16, 2010

(30) Foreign Application Priority Data
Jun. 19, 2007 (AU) 2007903281

(51) Int. Cl. H04L 27/28; H04L 27/00

(52) U.S. Cl. 375/260; 375/326

(57) ABSTRACT

The present invention relates to a method for carrier frequency offset (CFO) estimation for multicarrier communication systems. More particularly, but not limited to, the invention relates to CFO and timing estimation in communication systems that utilise multiple carriers to transmit signals. The multicarrier communication system has a large number of possible integer CFOs. First the received signal is auto-correlated (50) in the frequency domain to identify a set of most likely integer CFO values for further processing. Then the integer CFO is estimated (52) by using the channel impulse response on the set of most likely integer CFO values in the time domain to identify the value having the most energy concentrated within the first few temporal taps. The invention provides a two stage integer CFO estimation method that makes a trade off between performance and complexity. Aspects of the invention include a method, receiver, system and software.

### TECHNICAL FIELD

The present invention relates to a method for carrier frequency offset (CFO) estimation for multicarrier communication systems. More particularly, but not limited to, the invention relates to CFO and timing estimation in communication systems that utilise multiple carriers to transmit signals. Aspects of the invention include a method, receiver, system and software.

### BACKGROUND ART

Orthogonal frequency divisional multiplexing (OFDM) has received considerable attention for broadband wireless communications. OFDM utilises multiple carriers in order to transmit signals. The popularity of OFDM stems from its ability to transform a wideband frequency-selective channel to a set of parallel flat-fading narrowband channels, which substantially simplifies the channel equalization problem.

As a multicarrier transmission technique, OFDM is susceptible to carrier frequency offsets (CFOs), which is typically caused by instabilities between the transmitter and receiver local oscillators and/or Doppler shifts. If the CFO is not compensated by the receiver, the orthogonality among the subcarriers will be lost, which will lead to inter-carrier interference (ICI). Timing offset also has substantially adverse impacts on the performance of channel estimation and potentially increases the chance of inter-symbol interference (ISI).

The CFO can be several times large as the subcarrier spacing 1/T , where T is the effective OFDM symbol duration not including the cyclic prefix.

The CFO can be normalized by the subcarrier spacing and divided into two parts for the purpose of signal processing: an integer part and a fractional part. The integer part causes a circular shift of the transmitted symbol in the frequency domain and is the proportion of the CFO being an integral multiple of 1/T. The fractional part is the rest of the CFO in the range of ±1/T.

The link performance would be severely degraded if the integer and fractional CFOs are not properly compensated for by the receiver due to the ICI caused by the fractional part and a circular shift of the transmitted symbol caused by the integer part.

Since multicarrier modulation is based on a block transmission scheme, measures have to be taken to avoid or compensate for interblock interference (IBI), which contributes to the overall ISI. One avoidance scheme utilises the introduction of a guard time between consecutive OFDM symbols as a cyclic prefix (CP). A diagram of the preamble symbol in practical OFDM systems like IEEE 802.16 is shown in FIG. 1. Usually the preamble symbol has a repetition structure in time domain, and several null subcarriers known as guard bands 10 at two ends of the spectrum in the frequency domain. The CP 8 that precedes every OFDM symbol is chosen to be longer than the channel impulse response so that the ISI can be eliminated.

### SUMMARY OF THE INVENTION

In a first aspect the invention provides a method for estimating an integer part of a carrier frequency offset (CFO) in a multicarrier communication system having a large number of possible integer CFOs, the method comprising the steps of:
auto-correlating the received signal in the frequency domain to identify a set of most likely integer CFO values for further processing; and
estimating the integer CFO by using the channel impulse response on the set of most likely integer CFO values in the time domain to identify the value having the most energy concentrated within the first few temporal taps.

The invention provides a two stage integer CFO estimation method that makes a trade off between performance and complexity. The step of auto-correlation serves to identify a reduced number of likely integer CFOs in a manner having low complexity. This avoids performing the channel impulse response test, which has a higher complexity on all possible integer CFOs. Further, the invention is able to produce a satisfactory estimate despite the signal-to-noise ratio of the signal being low. Also, the trade-off allows desirable performance at reasonable complexity which is feasible for real-time processing on hardware.

The method may further comprise predetermining the number of most likely integer CFO values that comprise the set. This number is selected to adjust the trade-off between performance and complexity of the estimation.

The set may be comprised by the possible integer CFOs that have the highest auto-correlation. That is, the highest value for Γ(ε) as defined by:

$$Γ ( ɛ ) {=}^{Δ} {\sum }_{n = 0}^{{L}_{X} - 1} {\vert Y [ {α}_{n} - ɛ ] \vert}^{2}$$

where

ε is integer CFO

L_{X} is the number of used subcarriers in the preamble

n is a dummy variable representing the logical subcarrier indices

Y is the received signal in frequency domain after fractional CFO compensation

α is an array that maps logical subcarrier indices to physical subcarrier indices

The step of estimating the integer CFO may be based on a maximum likelihood measurement. The most likely integer CFO hypothesis and timing offset should concentrate most energy of the estimated channel impulse response within the first few temporal taps. Hence, the integer CFO and timing offset can be estimated as:

$${\tilde{ɛ}}_{i} , \tilde{τ} = arg {max}_{{ɛ}_{i} , τ} Λ ( {ɛ}_{i} , τ ) .$$

where

\tilde{ε}ᵢ is in the set of most likely integer CFO values

τ is in the set of all possible timing offset values

Λ(εᵢ,τ) is the norm of time-domain channel impulse response after truncation under integer CFO hypothesis εᵢ and time offset τ.

The method may further comprise estimating a timing offset in the multicarrier communication system wherein the first few temporal channel taps are the first few temporal taps following the estimated timing position.

The method may further comprise the initial step of compensating the received signal for a fractional part of the CFO. This has the advantage of reducing the high inter-carrier interference that would otherwise impair the performance of the estimation.

In a further aspect the invention provides software installed on a receiver of a multi carrier communication system to perform the method described above.

In yet a further aspect the invention provides receiver of a multi carrier communication system to estimate the integer part of carrier frequency offset (CFO) from a large number of possible integer CFOs, the receiver comprising:
an auto-correlator to auto correlate a received signal in the frequency domain to identify a set of most likely integer CFO values for further processing; and
an estimator to estimate the integer CFO by using the channel impulse response on the set of most likely integer CFO values in the time domain to identify the value having the most energy concentrated within the first few temporal taps.

In another aspect the invention provides system comprised of:
a transmitter; and
a receiver as described above, where the received signal is received from the transmitter.

### BRIEF DESCRIPTION OF THE DRAWINGS

FIG. 1 is a schematic diagram of one preamble symbol in practical OFDM systems.

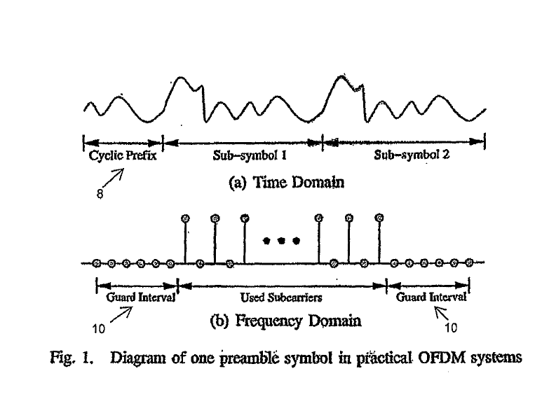

An example of the invention will now be described with reference to the following drawings, in which:

FIG. 2 is a schematic drawing of a receiver of a signal on an OFDM communications system;

FIG. 3 is a more detailed schematic diagram of the integer CFO estimator;

FIG. 4 graphically shows the channel impulse response of likely integer CFO values in the time domain; and

FIG. 5 shows graphically the performance of the estimator.

### BEST MODES OF THE INVENTION

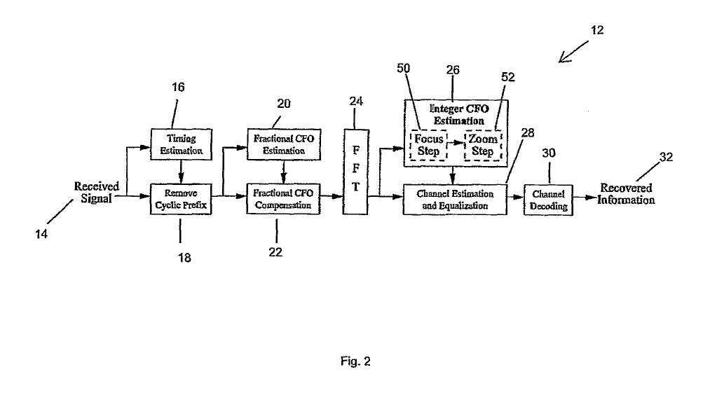

In this example, joint carrier frequency and timing offset estimation is performed. A receiver 12 in an OFDM system is schematically shown at FIG. 2. A timing estimator 16 of the receiver 14 synchronises the received signal in time and to remove the cyclic prefix (CP) 18. The fractional part of the CFO is then estimated by a Fractional CFO estimator 20 and compensated for using a fractional CFO compensator 22. A fast Fourier transformer (FFT) is provided to perform fast Fourier transform (FFT) 24 on the signal which is then used by an integer CFO estimator 26 to estimate the integer CFO and timing offset which are then used by the channel estimator and equalizer 28. The signal is then passed to a decoder 30 for output 32.

In the example described here, the OFDM system is a packet based system where a known preamble symbol is transmitted at the start of every packet to provide initial channel and frequency offset estimation. The time-domain signal of the preamble symbol reads

$$x ( t ) = \frac{1}{\sqrt{N}} {\sum }_{n = 0}^{{L}_{X} - 1} {X}_{n} {e}^{j 2 π ( {f}_{0} + {Δ}_{f} {α}_{n} ) t} \qquad ( 1 )$$

where N is the number of subcarriers; f₀ is the central frequency; Δ_{f} is the subcarrier spacing; X is a known phase shift keying (PSK) modulated sequence that satisfies E{X·X^{H}}=I_{L}_{ₓ} where I_{L}_{ₓ} is the identity matrix with order L_{X}; αₙ is the physical index of the subcarrier that carries the n^{th} element of X.

Each OFDM symbol is preceded by a CP that is chosen to be longer than the maximum channel delay to eliminate ISI. With perfect timing, after cyclic prefix removal, the OFDM preamble symbol at the receiver side is given by

y=\sqrt{N}e^{jφ}^{₀}diag(F(ε))W^{H}diag(X)Vh+w (2)

where φ₀ is a constant phase difference between the transmitter and receiver; w is a vector of independent additive Gaussian noise samples whose variances are σ²; h is the channel impulse response, which is assumed to be Lₕ long and invariant for one symbol period; W is part of the discrete Fourier transform (DFT) matrix whose entries are

$${W}_{n , k} = \frac{1}{\sqrt{N}} {e}^{- {j2πα}_{n} k / N} ,$$

and the first Lₕ columns of W made up another (Lₓ×Lₕ) truncated DFT matrix V. ε denotes the carrier frequency offset normalized by subcarrier spacing Δ_{f}, and the vector F(ε)Δ[1,e^{j2τε/N}, . . . , e^{j2τε(N-1)/N]}^{T} describes the phase rotating effect caused by frequency offset on each time domain samples at the receiver.

Fractional CFO Estimation

For practical OFDM systems where time-domain repetition structure exists in preamble symbols, quite simple fractional CFO estimation methods are given by Moose [2] and Yu [3]. For simplicity, we assume there are only two repeating sub-symbols in the preamble symbol, and briefly review the derivation of Moose's method to show where the ambiguity of integer CFO comes from.

### Define

$$γ {=}^{Δ} {\sum }_{k = 0}^{N / 2 - 1} {y}^{⋆} [ k ] y [ k + N / 2 ] \qquad ( 3 )$$

and it is easy to show

$$E \{ γ \} = {e}^{jπɛ} {\sum }_{k = 0}^{N / 2 - 1} {\vert \hat{y} [ k ] \vert}^{2} \qquad ( 4 )$$

where ŷ[k] is the k^{th} element of vector

ŷ=⇄\sqrt{N}W^{H}diag(X)Vh, (5)

which is the transmitted signal without the impairment of CFO, phase rotation, and AWGN noise. Thus, an unbiased fractional CFO estimator can be obtained from (4) according to [1] and [2] as

$${\tilde{ɛ}}_{f} = \frac{1}{π} angle ( γ ) \qquad ( 6 )$$

However, the time-domain method cannot distinguish integer CFO values because for all

ε=εᵢ+\tilde{ε}_{f} εᵢ=0±2,±4, (7)

the values of γ will be the same.

Integer CFO Estimation

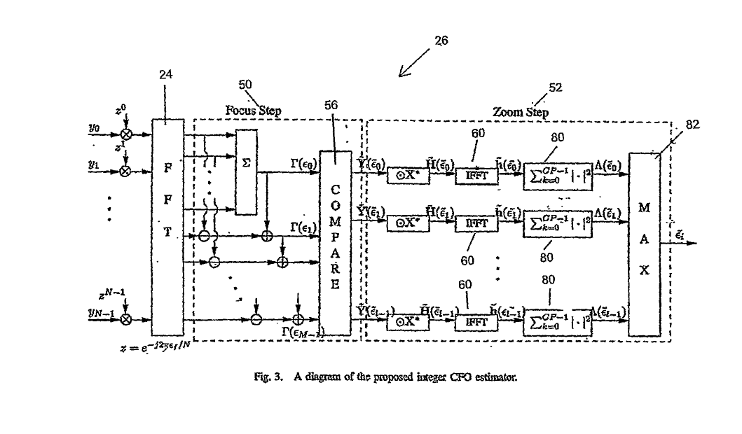

The operation of an integer CFO estimator 26 will now be described in further detail and with reference to FIG. 3. The method of integer CFO estimation is divided here into two parts: the focus step 50 and the zoom step 52.

After estimation 20 and compensation of fractional CFO 22 and fast Fourier transform (FFT) 24, the Focus step 50 is performed. The aim of the Focus step 50 is to go through a set of all possible integer CFOs M so as to identify the most likely ones for further hypothesis during testing in the zoom step 52. Considering the size of M may be quite large, we propose to use low-complexity methods based on frequency domain auto-correlation for the Focus step 50. Auto-correlation here is based on the sum of squared absolute values.

We can write the n^{th} subcarrier of received signal in frequency domain as

$$\begin{matrix}Y [ {α}_{n} - {\tilde{ɛ}}_{i} ] {=}^{Δ} \frac{1}{\sqrt{N}} {\sum }_{k = 0}^{N - 1} y [ k ] {e}^{- j 2 π \frac{k}{N} ( {\tilde{ɛ}}_{i} + {\tilde{ɛ}}_{f} )} {e}^{j 2 π \frac{k}{N} {α}_{n}} \\ = {e}^{j φ 0} {\sum }_{k = 0}^{N - 1} \hat{y} [ k ] {e}^{j 2 π \frac{k}{n} ( {α}_{n} + ( {ɛ}_{f} - {\tilde{ɛ}}_{f} ) + ( {ɛ}_{i} - {\tilde{ɛ}}_{i} ) )} + \hat{w} [ {α}_{n} - \tilde{{ɛ}_{i}} ] \\ = \hat{Y} [ {α}_{n} + ( {ɛ}_{i} - \tilde{{ɛ}_{i}} ) ] + \hat{w} [ {α}_{n} - {\tilde{ɛ}}_{i} ]\end{matrix} \qquad ( 8 )$$

where ŵ is a vector of Gaussian random variables that has the same statistical properties as the AWGN noise in the time domain,

$$\hat{Y} [ n ] {=}^{Δ} \frac{1}{\sqrt{N}} {\sum }_{k = 0}^{N - 1} \hat{y} [ k ] {e}^{j \frac{2 π}{N} nk} ; \qquad ( 9 )$$

and the last equality of (8) ignored fractional CFO estimation error because it is negligible after compensation by the fractional CFO estimates, given by (6), for the SNR range of interest. Define

$$Γ ( ɛ ) {=}^{Δ} {\sum }_{n = 0}^{{L}_{x} - 1} {\vert Y [ {α}_{n} - ɛ ] \vert}^{2} \qquad ( 10 )$$

then we have

$$\begin{matrix}E \{ Γ ( {ɛ}_{i} ) - Γ ( {ɛ}_{i} - 2 k ) \} = {\sum }_{n = 0}^{k} E \{ {\vert Y [ {α}_{n} - ɛ ] \vert}^{2} \} - \\ {\sum }_{n = 0}^{k - 1} E \{ {\vert \hat{w} [ {α}_{{L}_{x} - 1} + 2 n ] \vert}^{2} \} \\ = {\sum }_{n = 0}^{k} {\vert \hat{Y} [ {α}_{n} ] \vert}^{2} - k {σ}^{2} .\end{matrix} \qquad ( 11 )$$

This indicates the expectation of Γ(ε) reaches its maximum at a true integer CFO value, and larger estimation errors will result in smaller Γ(ε) values. Taking advantage of this property of Γ(ε), we propose to focus on a small set of integer CFO hypotheses \hat{M}ₗ that only consists of l hypotheses corresponding to the largest l values of Γ(ε). This set \hat{M}ₗ of most likely integer CFO values are identified by comparing all values for Γ(ε) at 54 by selecting the largest l values of Γ(ε).

The complexity of focus step 50 is dominated by Γ(ε) calculation for all εₗ∈M. According to the definition of Γ(ε) in (10), it takes 2N real multiplications and N additions to compute all |Y[k]|², and L_{X} additions to calculate the first Γ(ε), and then two additions for every other εᵢ∈M. Denote the size of M as M, the complexity of the focus step 50 is 2N real multiplications and N+Lₓ+2(M−1) real additions.

Next the zoom step 52 of the integer CFO estimation is performed on \hat{M}ₗ to validate the integer CFO hypotheses with the length of channel impulse response in time domain.

Assume \tilde{ε}ᵢ is an integer CFO hypothesis to test, define

\tilde{H}(\tilde{ε}ᵢ)[αₙ]ΔX[n]*Y[αₙ−\tilde{ε}ᵢ]. (12)

For correct integer CFO estimate \tilde{ε}_{c}, it is easy to show

\tilde{H}(\tilde{ε}_{c})[αₙ]=H[αₙ]+ŵ[αₙ−\tilde{ε}ᵢ]X*[n]

Therefore, \tilde{H}(\tilde{ε}_{c})[αₙ] is an unbiased estimate for channel frequency response, its inverse Fourier transform (IFFT) 60 is an unbiased estimate for channel impulse response, and

E{\tilde{h}(\tilde{ε}_{c})[k]|²}=|h[k]²+σ². (13)

where

$$\tilde{h} ( {\tilde{ɛ}}_{c} ) [ k ] {=}^{Δ} \frac{1}{\sqrt{N}} {\sum }_{n = 0}^{{L}_{x} - 1} \tilde{H} ( {\tilde{ɛ}}_{c} ) [ {α}_{n} ] {e}^{{j 2 πα}_{n} k / N} . \qquad ( 14 )$$

For incorrect integer CFO estimate \tilde{ε}_{w} ,

\tilde{H}(\tilde{ε}_{w})[αₙ]=X[n]*X[m]H[αₘ]+ŵ[αₙ−\tilde{ε}_{w}]X*[n].

Since X is usually a pseudo-random sequence, X*[n]X[m] add a random phrase rotation to the true channel frequency response, which leads to an AWGN-noise-like channel impulse response in time domain:

$$E \{ {\vert \tilde{h} ( {\tilde{ɛ}}_{w} ) [ k ] \vert}^{2} \} \approx \frac{1}{N} {‖ h ‖}^{2} + {σ}^{2} . \qquad ( 15 )$$

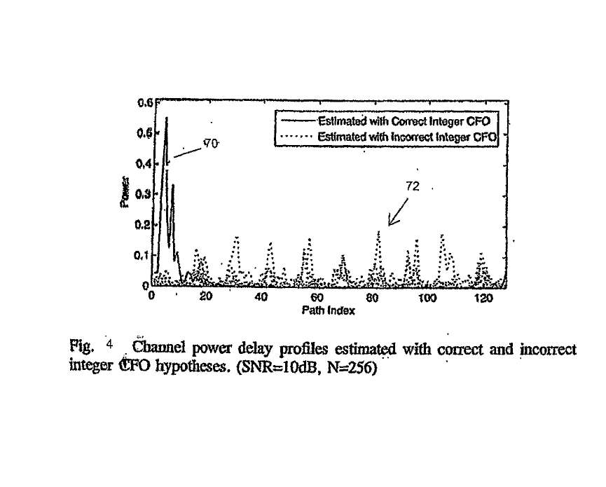

FIG. 4 visualizes what (13) and (15) reveal. We can see the channel impulse response estimated under correct integer CFO hypothesis 70 has most of its energy concentrated within the first several taps following the correct timing position whereas wrong hypotheses have the power much more evenly distributed 72. Exploiting this feature, we propose to construct the objective function as

$$Λ ( {ɛ}_{i} , τ ) = {\sum }_{k = τ}^{τ + CP - 1} {\vert \tilde{h} ( {ɛ}_{i} ) [ k ] \vert}^{2} , \qquad ( 16 )$$

shown at 80 which is expected to achieve the maximum 82 at the correct integer CFO hypothesis and timing position, so

$$\{ \tilde{{ɛ}_{i}} , \tilde{τ} \} = arg {max}_{{ɛ}_{i} , τ} Λ ( {ɛ}_{i} , τ ) . \qquad ( 17 )$$

The maximum value of \tilde{ε}ᵢ and \tilde{τ} determined at 82 is the integer CFO and timing offset that is used for compensating 28 for CFO and timing offset by the receiver 12.

For every integer CFO hypothesis of \hat{M}ₗ, the Zoom step 52 needs to do one inverse fast Fourier transform (IFFT) 60, (2N) real multiplications, and (2N) real additions. The overall complexity of Zoom step 52 is O(N log₂ N).

Equation (16) can also be written in matrix format as

Λ(εᵢ)=(V^{H}\tilde{H}(εᵢ))^{H}(V^{H}\tilde{H}(εᵢ))=^{H}diag (F(ε))Ddiag(F(−ε))y (18)

where

DΔW^{H}diag(X)VV^{H}diag(X*)W. (19)

The diagram of the proposed integer CFO estimator is shown in FIG. 3. We can see this structure is very suitable for pipelined implementation on a Field Programmable Gate-Array (FPGA) or Application-Specific Integrated Circuit (ASIC), and high speed can be achieved in a small area.

The numerical results presented in this section all use the preamble symbol defined in IEEE 802.16 standard, which has N=256 subcarriers, and only even subcarriers are used. This leads to two repeating sub-symbols of 128-samples long in time-domain. Two guard intervals consist of 27 and 28 null subcarriers are allocated at two ends of the frequency spectrum. The cyclic prefix is fixed to 64 samples long in simulations.

The stationary wireless communication channel is modelled by a 64-tap delay line with constant power delay profile. The power of k^{th} path equal to e^{-k/5}, and the phases of each paths are independent random variables uniformly distributed in [0,2τ).

The mobile channel model follows the recommendation of [4], where 6 taps of the channel with relative delays {0, 310 ns, 710 ns, 109 Ons, 1730 ns, 2510 ns} and relative power levels {0 dB, −1 dB, −9 dB, −10 dB, −15 dB, 20 dB} are assumed. Each channel taps are modelled by independent Jake's models. An IEEE 802.16 OFDM system runs at 2.3 GHz carrier frequency with 10 MHz bandwidth is simulated. For vehicles moving at speed 120 Km/h, the maximum Doppler frequency for the time-varying channel is

$${f}_{d} = \frac{120 \times \frac{{10}^{3}}{3600}}{3 \times {10}^{8}} \times 2.3 GHz = 255.6 Hz .$$

For the mobile channels, we can expect performance loss resulted from the modelling mismatch we mentioned above.

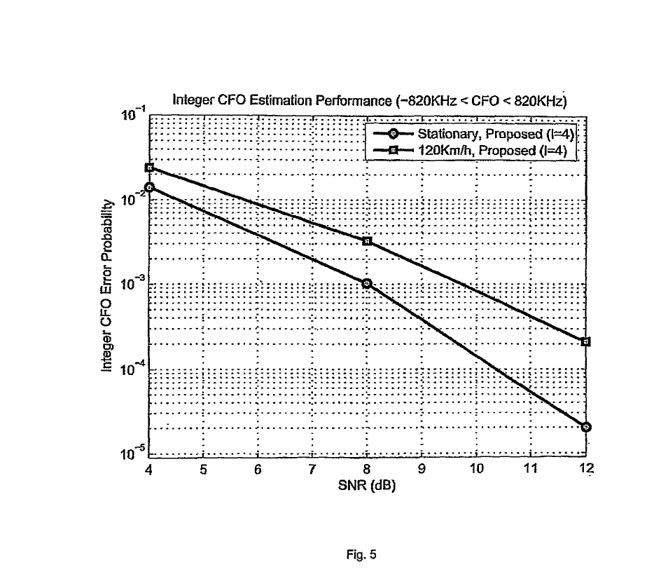

The performance of integer CFO estimation is measured by the number of error events counted for a large number of OFDM bursts. At least 10⁴ independent experiments and 100 error events are observed for every point plotted in FIG. 5. The true CFO value is modelled by a random variable uniformly distributed within (−21,21) subcarrier spacing, and the rough fractional CFO estimate is provided by Moose estimator [2]. To limit the complexity of proposed estimator, only l=4 integer CFO hypotheses are tested at zoom step 52.

With 4 hypotheses tested at zoom step 52, the estimator of this embodiment of the invention provides reasonable performance and complexity trade-off in the operational SNR region for most practical OFDM systems.

In mobile channels, 2 dB performance degradation is observed for the proposed estimator, which is acceptable for most OFDM.

This shows that the invention provides a two-stage integer CFO estimator to give a flexible trade-off between performance and complexity for practical OFDM systems. Further this satisfactory performance can be achieved with limited hardware resource available.

The invention could be used as part of a femto base station in “sniffer” mode to determine accurate timing and frequency from surrounding macro base stations, possibly avoiding the need for an expensive crystal oscillator chip and therefore reducing the Bill of Materials (BOM). As the femto could be receiving very week signals from surrounding macro base stations this is a technique that could significantly assist femto synchronisation in the shortest time possible. This technique could be used during compressed mode (a short silent period forced by the femto) to re-check timing from macro base stations.

The invention assumes multipath channel rather than a single path channel. The invention is suitable for use in communication systems that utilise multiple carriers to transmit communication signals. These include Orthogonal Frequency Division Multiplexing (OFDM) communications systems, MIMO-OFDM (multiple-input multiple-output-OFDM) systems, Orthogonal Frequency Division Multiple Access (OFDMA) systems, MIMO-OFDMA, COFDM (Coded OFDM), Multi-carrier—code-division multiple-access (MC-CDMA) systems, Digital Subscriber Line (xDSL) communications techniques, Digital Audio Broadcast (DAB) communication techniques and Digital Video Broadcasting (DVB) communication techniques.

It will be appreciated by persons skilled in the art that numerous variations and/or modifications may be made to the invention as shown in the specific embodiments without departing from the spirit or scope of the invention as broadly described. The CFO and timing estimation need not be performed jointly if there is no timing offset, that is if is known prior.

The present embodiments are, therefore, to be considered in all respects as illustrative and not restrictive.

### REFERENCES

[1] Timothy M Schmidl and Donald C Cox, “Robust frequency and timing synchronisation for OFDM,” IEEE Transactions on Communications, vol 45, pp. 1613-1621, December 1997.

[2] Paul H Moose, “A technique for orthogonal frequency division multiplexing frequency offset correction,” IEEE Transactions on Communications, vol 42, pp. 2908-2914, October 1994.

[3] Juin H Yu and Yu T Su “Pilot-assisted maximum-likelihood frequency-offset estimation for OFDM systems,” IEEE Transactions on Communications, vol 52, pp. 1997-2008, November 2004.

[4] ITU-R M.1225, “Guidelines for evaluation of radio transmission technologies for imt-2000,” Recommendation ITU-R M 1225, 1997,

1. A method for estimating an integer part of a carrier frequency offset (CFO) in a multicarrier communication system having a large number of possible integer CFOs, the method comprising the steps of:
auto-correlating the received signal in the frequency domain to identify a set of most likely integer CFO values for further processing; and
estimating the integer CFO by using the channel impulse response on the set of most likely integer CFO values in the time domain to identify the value having the most energy concentrated within the first few temporal taps.

2. A method of claim 1, wherein the method further comprises predetermining the number of most likely integer CFO values that comprise the set.

3. A method of claim 2, wherein the number is selected to adjust the trade-off between performance and complexity of the method.

4. A method of claim 1, wherein the set is be comprised of the possible integer CFOs that have the highest auto-correlation.

5. A method according to claim 4, wherein the auto-correlation is defined by:
$$Γ ( ɛ ) {=}^{Δ} {\sum }_{n = 0}^{{L}_{x} - 1} {\vert Y [ {α}_{n} - ɛ ] \vert}^{2}$$
where
ε is integer CFO
Lₓ is the number of used subcarriers in the preamble
n is a dummy variable representing the logical subcarrier indices
Y is the received signal in frequency domain after fractional CFO compensation
α is an array that maps logical subcarrier indices to physical subcarrier indices

6. A method according to claim 1, wherein the step of estimating the integer CFO is based on a maximum likelihood measurement.

7. A method according to claim 1, wherein the method further comprises estimating a timing offset in the multicarrier communication system having a set of possible timing offsets, wherein the first few temporal channel taps are the first few temporal taps following the estimated timing position.

8. A method according to claim 7, wherein the most energy concentrated within the first few temporal taps is defined by:
$$\tilde{{ɛ}_{i}} , \tilde{τ} = arg \frac{max}{{ɛ}_{i} , τ} Λ ( {ɛ}_{i} , τ ) .$$
where
\tilde{ε}ᵢ is in the set of most likely integer CFO values
τ is in the set of all possible timing offsets
Λ(εᵢ, τ) is the norm of time-domain channel impulse response after truncation under integer CFO hypothesis εᵢ, and timing offset τ.

9. A method according to claim 1, wherein the method further comprises the initial step of compensating the received signal for a fractional part of the CFO.

10. A method according to claim 1, wherein the communication system is an orthogonal frequency division multiplexing (OFDM) system.

11. Software installed on a receiver of a multicarrier communication system to perform the method according to claim 1.

12. A receiver of a multicarrier communication system to estimate the integer part of carrier frequency offset (CFO) from a large number of possible integer CFOs, the receiver comprising:
an auto-correlator to auto correlate a received signal in the frequency domain to identify a set of most likely integer CFO values for further processing; and
an estimator to estimate the integer CFO by using the channel impulse response on the set of most likely integer CFO values in the time domain to identify the value having the most energy concentrated within the first few temporal taps.

13. A multicarrier communication system comprised of a transmitter; and
a receiver according to claim 12, where the received signal is received from the transmitter.
